(19) United States
(12) Patent Application Publication
(10) Pub. No.: US 2020/0340575 A1
(43) Pub. Date: Oct. 29, 2020

(54) DRIVELINE BETWEEN A ROTOR AND A GENERATOR OF A WIND TURBINE

(71) Applicant: Aktiebolaget SKF, Göteborg (SE)

(72) Inventor: Edgar Pickel, Sommerach (DE)

(21) Appl. No.: 16/923,571

(22) Filed: Jul. 8, 2020

Related U.S. Application Data
(63) Continuation of application No. 15/005,240, filed on Jan. 25, 2016, now abandoned.

(30) Foreign Application Priority Data
Jan. 23, 2015 (DE) 102015201171.2

(51) Int. Cl. F16H 57/08; F03D 80/70; F03D 15/00; F16C 33/37; F03D 15/10; F16C 19/40

(52) U.S. Cl. CPC F16H 57/082; F03D 80/70; F03D 15/00; F16C 33/3706; F03D 15/10; Y02E 10/722; F16C 2360/31; F16C 2208/36; F16C 2220/04; F05B 2260/40311; F05B 2280/4009; F16C 19/40

(57) ABSTRACT

A driveline configured to connect a wind turbine rotor and a wind turbine generator has a planetary gear unit having a planet carrier rotatably supported relative to a housing part by at least one rolling-element bearing. The rolling-element bearing includes at least one inner ring and least one outer ring, and a plurality of rolling elements are disposed between the at least one inner ring and the at least one outer ring. The rolling element bearing further includes a spacer element disposed between adjacent pairs of the plurality of rolling elements, the spacer elements each having first and second running surfaces for guiding first and second ones of the plurality of rolling elements, and, apart from the spacer elements, a region between the bearing rings includes no cage elements.

### CROSS-REFERENCE

This application claims priority to and benefit of the following applications, as follows: this application is a continuation of and claims priority to and benefit of U.S. patent application Ser. No. 15/005,240 filed on Jan. 25, 2016, which claims priority to German patent application no. DE 102015201171.2, filed on Jan. 23, 2015; each of the above identified applications is hereby incorporated herein by reference as if fully set forth in its entirety.

### TECHNOLOGICAL FIELD

The disclosure is directed to a driveline located between a rotor and a generator of a wind turbine, the driveline including a planetary gear unit that includes a planet carrier. The planet carrier is rotatably supported relative to a housing part by at least one rolling-element bearing having at least one inner ring, at least one outer ring, and rolling elements between the inner and outer rings.

### BACKGROUND

A wind turbine requires a driveline in order to conduct the torque generated by a rotor at its hub to a generator in a process that allows electrical energy to obtained from wind energy. For this purpose the rotation of the rotor must be translated, and a planet gear unit can be used for this purpose. An example of a planetary gear unit of a wind turbine is described in DE 10 2012 214 023 B3, a family member of U.S. Pat. Nos. 9,115,800, and 9,115,800 is hereby incorporated by reference.

In order to support a planet carrier of a planetary gear unit in wind power applications, full complement cylindrical roller bearings (or sometimes tapered roller bearings) are generally used. One of the principal reasons for using full complement bearings is that they require no cage and are thus more cost-effective than bearings that require cages. This can be particularly advantageous in view of the large size of the bearings generally required for wind turbines.

However, when full complement bearings are used, there is a risk of “smearing.” Smearing occurs when two inadequately lubricated surfaces slide against each other under load and material is transferred from one surface to the other. The sliding surfaces involved may become scored and develop a “torn” appearance. When smearing occurs, the material is generally heated to such temperatures that re-hardening takes place. This produces localized stress concentrations that may cause cracking or flaking. Smearing is undesirable in wind turbine applications and may result in the rolling elements and possibly also the bearing rings becoming black oxidized. This in turn has a negative effect on cost.

A further disadvantage of full complement bearings is that these bearings are separable, that is, the individual parts of the bearing are only held together when the bearing is installed. If the shaft or the inner ring is removed, the individual bearing elements, such as the rollers, are prone to falling out of the bearing assembly.

In contrast, the high load rating that can be achieved by a full complement bearing is usually not needed in the above-described application.

### SUMMARY

An aspect of the disclosure is to provide a driveline having a planetary gear unit of the above-described type. This allows the bearing assembly to be embodied more cost-effectively, while still providing a sufficient stability of the bearing. Furthermore, the installation and removal of the bearing assembly is possible in a simpler manner than is the case when full complement bearings are used.

The disclosure involves disposing a spacer element between each two adjacent pairs of rolling elements. The spacer element includes running surfaces for the two adjacent rolling elements, and, viewed from the spacer elements, the region between the bearing rings is free from further cage elements.

The spacer element is preferably comprised of plastic, preferably polyether ether ketone (PEEK). The spacer element is preferably manufactured by injection molding.

The rolling elements preferably have a hardened and ground surface, which, however, is free from black oxidation.

The spacer element can be disposed between the bearing rings such that it lies with its radially inner-lying end radially below the bearing pitch circle and with its radially outer-lying end radially above the bearing pitch circle. This helps hold the bearing elements together even when the inner ring or shaft is removed.

The spacer elements can be connected to one another by a connecting element such as a cord or a cable. This helps prevent the bearing parts from falling apart during the partial removal of bearing parts and improves the connection between the parts.

The rolling-element bearing is preferably configured as a cylindrical roller bearing.

However, embodiments using tapered roller bearing are also possible. In such an embodiment, two axially spaced tapered roller bearings would be axially preloaded against each other.

The disclosure thus avoids the costs caused by black oxidized rolling elements (rollers). Instead, a cage-spacer piece (spacer) made from a suitable material for holding and guiding the rolling elements is used without using a cage. In this regard, the material PEEK has proven particularly useful. Advantageously the cage-spacer piece prevents smearing from occurring.

Furthermore, the presence of the cage-spacer pieces reduces the number of expensive rollers that are required for a bearing of a given diameter. Because the plastic spacers are less expensive that rollers, the cost of the bearing is reduced.

Another aspect of the disclosure comprises a driveline configured to connect a wind turbine rotor and a wind turbine generator. The driveline includes a planetary gear unit having a planet carrier rotatably supported relative to a housing part by at least one cage-less rolling-element bearing. The cage-less rolling-element bearing includes at least one inner ring and least one outer ring, and a plurality of rolling elements disposed between the at least one inner ring and the at least one outer ring. The rolling element bearing further includes a spacer element disposed between adjacent pairs of the plurality of rolling elements, the spacer elements each having first and second running surfaces for guiding one of the plurality of rolling elements. A further aspect of the disclosure comprises a similar driveline that includes spacer means.

A further advantage is that with the disclosed design of the planet-carrier bearing the bearing can be better held together by suitable construction of the spacer piece (i.e. of the spacer). Thus the handling, and optionally the bearing control and assembly, can be improved and simplified.

### BRIEF DESCRIPTION OF THE DRAWINGS

An exemplary embodiment of the invention is depicted in the drawings:

FIG. 1 is a schematic radial section through part of a planetary gear unit usable as a component of a driveline of a wind turbine.

FIG. 2 is a schematic side elevational view of two adjacent rolling elements of a rolling-element bearing and two spacer elements for a planetary gear unit according to an embodiment of the disclosure.

FIG. 3 is a schematic side elevational view of two adjacent rolling elements of a rolling-element bearing and two spacer elements for a planetary gear unit connected by a cord according to an embodiment of the disclosure.

### DETAILED DESCRIPTION

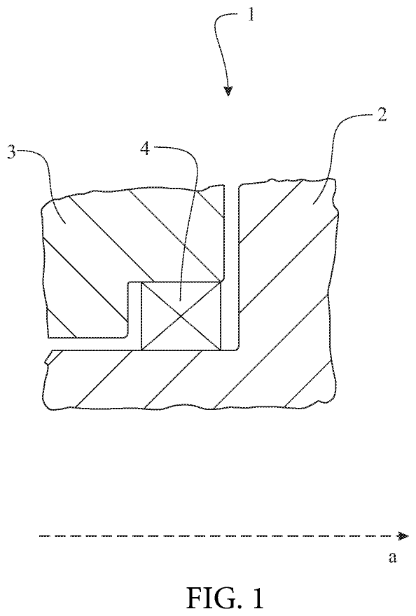

In FIG. 1 a part of a planetary gear unit 1 is schematically illustrated, which in this case serves to translate the rotational movement of a (not depicted) wind turbine rotor in the driveline between the rotor and a (not depicted) generator. The planetary gear unit 1 includes a planet carrier 2 that is supported relative to a housing part 3 by a rolling-element bearing 4. The planet carrier 2 is thus rotatable about the axis a.

The design of a planetary gear unit is well known and will not be described further herein. However, a suitable planetary gear unit is shown in the aforementioned DE 10 2012 214 023 B3, and various embodiments can be found therein.

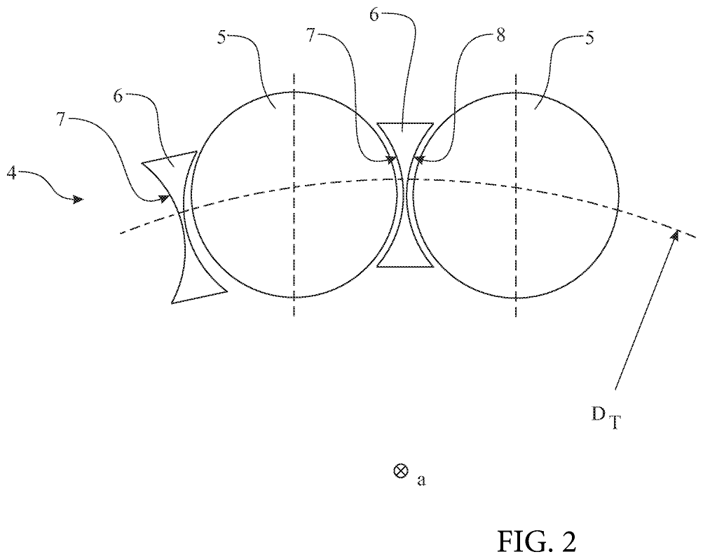

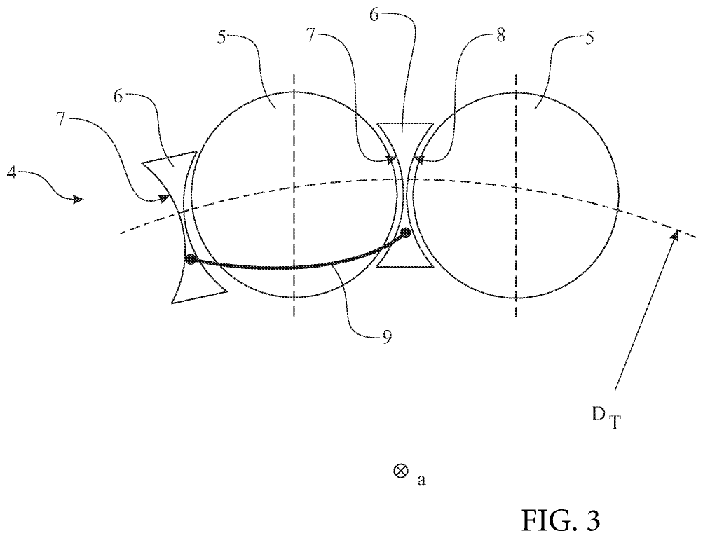

The design of the rolling-element bearing 4 can be seen in FIG. 2, where two adjacent rolling elements 5 and two spacer elements 6 are illustrated. One spacer element 6 is disposed between each pair of adjacent tolling elements 5. FIG. 3 shows that the spacer elements 6 on either side of one of the rolling elements 5 may be connected by a cord or cable 9.

The spacer elements 6 are comprised of plastic and as such are known as spacers in rolling-element bearings. For this purpose DE 10 2011 087 864 A1 of the applicant is referred to and expressly referenced, which shows general cage segments of a similar type. This document is a family member of US 2015/0078699, and US 2015/0078699 is hereby incorporated by reference.

Each spacer element 6 includes lateral running surfaces 7 and 8 that are configured to be complementary to the shape of the rolling elements 5. As can be seen from FIG. 2, the spacer elements 6 extend with their radially outer ends beyond the pitch circle having the pitch circle diameter DT; likewise they extend with their radially inner ends below the pitch circle. Thus a non-separable unit can be provided when the bearing outer ring or the bearing inner ring is removed.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved drivelines for wind turbines.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Planetary gear unit

2 Planet carrier

3 Housing part

4 Rolling-element bearing

5 Rolling elements

6 Spacer element

7 Running surface

8 Running surface

9 Cord

a Axial direction

DT Diameter of the pitch circle

1. A driveline configured to connect a wind turbine rotor and a wind turbine generator, the driveline comprising:
a planetary gear unit having a planet carrier rotatably supported relative to a housing part by a rolling-element bearing; the rolling-element bearing comprising:
an inner ring and an outer ring, and a plurality of rolling elements disposed between the inner ring and the outer ring and configured for relative motion therebetween about a rolling-element bearing axis of rotation;
a plurality of spacer elements each of which is disposed between a separate one of adjacent pairs of the plurality of rolling elements;
the plurality of spacer elements each having a first running surface and a second running surface for guiding one of the plurality of rolling elements, each of the plurality of spacer elements having lateral rolling surfaces comprising a first running surface and a second running surface for guiding one of the plurality of rolling elements, the lateral rolling surfaces being configured as complementary to a shape of the plurality of rolling elements;
wherein, apart from the spacer elements and components thereof, a region between the inner ring and the outer ring includes no cage elements such that at least one rolling-element bearing is a non-separable unit; and
the plurality of the spacer elements are each connected to adjacent ones of the plurality of spacer elements by one of the group of a cord and a cable, the one of the group of the cord and the cable being located entirely radially inwardly from a pitch circle diameter of the rolling-element bearing, the pitch circle diameter, as measured from the rolling-element bearing axis of rotation, intersects a lowest point on an outer surface of each of the plurality of rolling elements that intersect a rolling element axis of rotation thereof.

2. The driveline of claim 1, wherein the one of the group of the cord and the cable has first and second ends each connecting directly to a radially extending surface of each of the adjacent ones of the plurality of spacer elements.

3. The driveline of claim 1, wherein the plurality of spacer elements are comprised of plastic.

4. The driveline of claim 3, wherein the plastic is polyetheretherketone (PEEK).

5. The driveline of claim 3, wherein each of the plurality of spacer elements is an injection molded spacer element.

6. The driveline of claim 1, wherein the plurality of rolling elements have a hardened and ground surface and are free from black oxidation.

7. The driveline of claim 1, wherein each of the plurality of spacer elements has a radially inner-lying end and a radially outer lying end, the radially inner-lying end lies radially inwardly from the pitch circle diameter of the rolling-element bearing and the radially outer-lying end lies radially outward from the pitch circle diameter.

8. The driveline of claim 1, wherein the rolling-element bearing is a cylindrical roller bearing.

9. The driveline of claim 1, wherein two axially spaced tapered roller bearings are axially preloaded against each other.

10. The driveline of claim 1, wherein the plurality of spacer elements are comprised of injection molded polyetheretherketone (PEEK) and the plurality of rolling elements each have a hardened and ground surface and are free from black oxidation, each of the plurality of spacer elements has a radially inner-lying end and a radially outer lying end, the radially inner-lying end lies radially inwardly from the pitch circle diameter of the rolling-element bearing and the radially outer-lying end lies radially outward from the pitch circle diameter.

11. A driveline configured to connect a wind turbine rotor and a wind turbine generator, the driveline comprising:
a planetary gear unit having a planet carrier rotatably supported relative to a housing part by a rolling-element bearing; the rolling-element bearing comprising:
an inner ring and an outer ring, and a plurality of rolling elements disposed between the inner ring and the outer ring and configured for relative motion therebetween about a rolling-element bearing axis of rotation;
a plurality of spacer elements each of which is disposed between a separate one of adjacent pairs of the plurality of rolling elements, the plurality of spacer elements each having a first running surface and a second running surface for guiding one of the plurality of rolling elements, each of the plurality of spacer elements having lateral rolling surf aces comprising a first running surface and a second running surface for guiding one of the plurality of rolling elements, the lateral rolling surfaces being configured as complementary to a shape of the plurality of rolling elements;
wherein, apart from the spacer elements and components thereof, a region between the inner and the outer bearing rings includes no cage elements such that at least one rolling-element bearing is a non-separable unit; and
the plurality of the spacer elements are each connected to adjacent ones of the plurality of spacer elements by a flexible connector, the flexible connector being located entirely radially inwardly from a pitch circle diameter of the rolling-element bearing, the pitch circle diameter, as measured from the rolling-element bearing axis of rotation, intersects a lowest point on an outer surface of each of the plurality of rolling elements that intersect a rolling element axis of rotation thereof.

12. The driveline of claim 11, wherein the flexible connector has first and second ends each connecting directly to a radially extending surface of each of the adjacent ones of the plurality of spacer elements.

13. The driveline of claim 11, wherein the plurality of rolling elements have a hardened and ground surface and are free from black oxidation.

14. The driveline of claim 11, wherein each of the plurality of spacer elements has a radially inner-lying end and a radially outer lying end, the radially inner-lying end lies radially inwardly from the pitch circle diameter of the rolling-element bearing and the radially outer-lying end lies radially outward from the pitch circle diameter.

15. The driveline of claim 12, wherein the flexible connector is one of the group of a cable and a cord.

16. The driveline of claim 1, wherein the rolling-element bearing is cageless.

17. The driveline of claim 11, wherein the rolling-element bearing is cageless.

18. The driveline of claim 1, wherein the first running surface and the second running surface define a path which is oriented perpendicularly to the rolling-element bearing axis of rotation.

19. The driveline of claim 11, wherein the first running surface and the second running surface define a path which is oriented perpendicularly to the rolling-element bearing axis of rotation.
